(19) United States
(12) Patent Application Publication
(10) Pub. No.: US 2026/0035002 A1
(43) Pub. Date: Feb. 5, 2026

(54) DRIVE ASSIST DEVICE

(71) Applicant: TOYOTA JIDOSHA KABUSHIKI KAISHA, Toyota-shi (JP)

(72) Inventor: Eiji NUNOBIKI, Mishima-shi (JP)

(73) Assignee: TOYOTA JIDOSHA KABUSHIKI KAISHA, Toyota-shi (JP)

(21) Appl. No.: 19/051,372

(22) Filed: Feb. 12, 2025

(30) Foreign Application Priority Data
Jul. 31, 2024 (JP) 2024-124312

(51) Int. Cl. B60W 50/14; B60W 30/09

(52) U.S. Cl. CPC B60W 50/14; B60W 30/09; B60W 2050/146; B60W 2540/229

(57) ABSTRACT

The drive assist device is configured to perform notification control for notifying the driver of the presence of the obstacle when the contact risk between the obstacle and the vehicle is equal to or greater than the first threshold, and perform deceleration control for decelerating the vehicle when the contact risk is equal to or greater than the second threshold that is greater than the first threshold. Further, the drive assist device is configured to specify a recognition level for notification by notification control of the driver, and change at least one of a control mode of the notification control and the deceleration control based on the recognition level.

### CROSS-REFERENCE TO RELATED APPLICATION

This application claims priority to Japanese Patent Application No. 2024-124312 filed on Jul. 31, 2024. The disclosure of the above-identified application, including the specification, drawings, and claims, is incorporated by reference herein in its entirety.

### BACKGROUND

### 1. Technical Field

The present disclosure relates to a drive assist device that executes notification control for notifying a driver of the presence of an obstacle and deceleration control for decelerating a vehicle in order to reduce the risk of contact with the obstacle.

### 2. Description of Related Art

Conventionally, there has been known a drive assist device that executes deceleration control when the risk of contact with an obstacle increases. For example, Japanese Unexamined Patent Application Publication No. 2017-182768 (JP 2017-182768 A) discloses a drive assist device (hereinafter referred to as a “conventional device”) that executes deceleration control when both of the following execution condition 1 and execution condition 2 are satisfied, in order not to execute unnecessary deceleration control.
Execution condition 1: a collision between a vehicle and an obstacle is predicted within the range of a width smaller than the estimated course of the vehicle from the center of the vehicle.
Execution condition 2: an obstacle is located within a predetermined range from the center of the estimated course of the vehicle.

### SUMMARY

There is known a drive assist device that executes notification control for notifying a driver of the presence of an obstacle before executing deceleration control. If the deceleration control is executed when the driver sufficiently recognizes the notification by the notification control, the driver may be annoyed by the deceleration control. Similarly, if the notification control is continued when the driver sufficiently recognizes the notification by the notification control, the driver may be annoyed by the notification control.

The present disclosure has been made to address the above-mentioned issue. In other words, an object of the present disclosure is to provide a drive assist device capable of reducing the possibility that a driver is annoyed by notification control and/or deceleration control.

The drive assist device according to the present disclosure (hereinafter referred to as a “present disclosure device”) is
a drive assist device configured to perform notification control for notifying a driver of presence of an obstacle (OB) when a risk of contact between the obstacle and a vehicle (VA) is equal to or more than a first threshold value (step 525, step 535, step 540), and to perform deceleration control for decelerating the vehicle when the risk of contact is equal to or more than a second threshold value larger than the first threshold value (step 560, step 570).
   Further, the drive assist device is configured to:
specify a recognition level of the driver for a notification by the notification control (step 400 to step 495); and
change a control mode of at least one of the notification control and the deceleration control based on the recognition level (step 520 to step 540, step 555 to step 570).

According to the present disclosure device, the control mode of at least one of the notification control and the deceleration control is changed based on the recognition level. When the control mode is changed so as to be suppressed when the recognition level is high as compared with when the recognition level is low, it is possible to reduce the possibility that the same notification control and deceleration control are executed when the driver recognizes the notification target as when the driver does not recognize the notification target. Accordingly, it is possible to reduce the possibility that the driver is annoyed by the notification control and the deceleration control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a drive assist device according to an embodiment of the present disclosure;

FIG. 2 is an explanatory diagram of an outline of operation of the drive assist device according to the embodiment of the present disclosure;

FIG. 3 is a flow chart of a notification determination routine executed by CPU of ECU shown in FIG. 1;

FIG. 4 is a flow chart of a cognitive level-specific routine performed by CPU of ECU shown in FIG. 1; and

FIG. 5 is a flow chart of a control executor executed by CPU of ECU shown in FIG. 1.

### DETAILED DESCRIPTION OF EMBODIMENTS

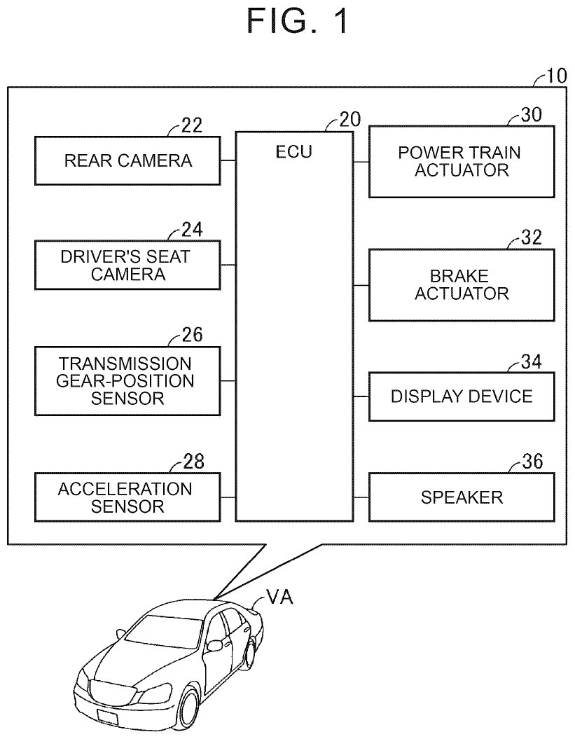

As illustrated in FIG. 1, the drive assist device 10 (hereinafter, referred to as “the present device 10”) according to the present embodiment is applied to a vehicle VA.

The present device 10 comprises the components shown in FIG. 1. In the present specification, “ECU 20” is an electronic control device including a microcomputer as a main part. ECU 20 is also referred to as control units, controllers and computers. The microcomputer includes a CPU (processor), a ROM, RAM, interfaces, and the like. The function realized by ECU 20 may be realized by a plurality of ECU.

The rear-camera 22 captures a landscape behind the vehicle VA to obtain rear-view images. The driver's seat camera 24 acquires driver's seat images by capturing a predetermined area of the driver's seat in the vehicle VA. The predetermined area is set to include a face of an occupant (that is, a driver) located in the driver's seat. ECU 20 acquires the rear image and the driver's seat image from the rear camera 22 and the driver's seat camera 24, respectively.

The shift position sensor 26 detects a set position SP of a shift lever (not shown) mounted on the vehicle VA. The driver can set the shift lever to one of the forward position (D range), the backward position (R range), the neutral position (N range), and the parking position (P range). The acceleration sensor 28 detects an acceleration G in the front-rear axial direction of the vehicle VA. ECU 20 acquires the detected values from the shift position sensor 26 and the acceleration sensor 28, respectively, and specifies the set position SP of the shift lever and the acceleration G of the vehicle VA.

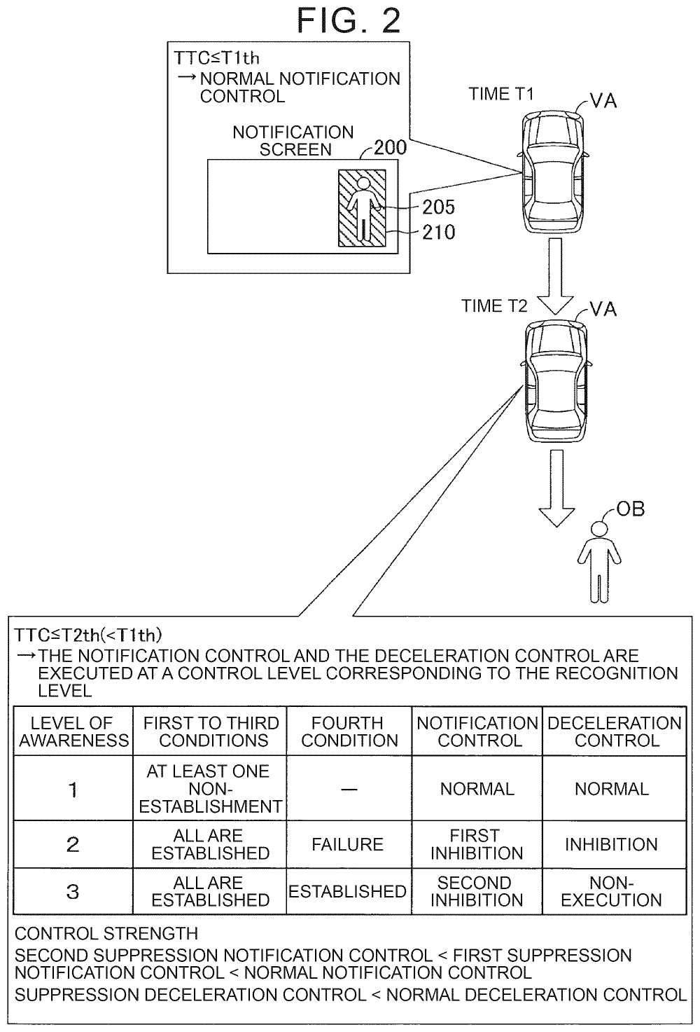

The powertrain actuator 30 changes a driving force generated by a driving device (for example, an internal combustion engine and/or an electric motor) of the vehicle VA. The brake actuator 32 changes the braking force applied to the vehicle VA. A notification screen 200 (see FIG. 2) to be described later is displayed on the display device 34. The speaker 36 generates a notification sound to be described later.

### Notification Control

When an obstacle OB having a TTC (Time To Collision) equal to or less than the first threshold-time T1th is present behind the vehicle VA while the vehicle VA is moving backward (see the time-point t1 in FIG. 2), ECU 20 executes a normal notification control for notifying the driver of the presence of the obstacle. Specifically, ECU 20 displays a notification screen 200 (see FIG. 2) on the display device 34 and causes the speaker 36 to pronounce a predetermined notification sound. A rear image is displayed on the notification screen 200. As illustrated in FIG. 2, in the notification screen 200, a notification target image 205 representing an image of an obstacle OB whose TTC is equal to or less than the first threshold-time T1th (hereinafter, referred to as a “notification target”) is surrounded by a rectangle 210, whereby the notification target image 205 is highlighted.

TTC represents the amount of time it takes for the obstacle OB to touch the vehicle VA. It is also possible to express the risk of contact between the obstacle OB and the vehicle VA. The shorter TTC, the higher the risk of exposure. TTC is obtained by dividing the distance between the obstacle OB and the vehicle VA by the relative velocity of the obstacle OB with respect to the vehicle VA. The distance and the relative velocity are acquired based on a back image. TTC may also be referred to as a contact risk indicator or contact duration.

### Deceleration Control

When the vehicle VA further retreats after executing the notification control and TTC becomes smaller than or equal to the second threshold time T2th smaller than the first threshold time T1th (see the time point t2 in FIG. 2), deceleration control for decelerating the vehicle VA is performed by ECU 20.

### Overview of Operation

ECU 20 specifies a recognition level of the driver with respect to the notification of the notification control, and changes a control mode of at least one of the notification control and the deceleration control based on the recognition level. Specifically, ECU 20 suppresses at least one of the notification control and the deceleration control when the cognitive level is higher than when the cognitive level is lower.

Accordingly, when the recognition level is high, the suppressed notification control and/or the deceleration control is executed as compared with the case where the recognition level is low. Therefore, it is possible to reduce the possibility that the notification control and/or the deceleration control of the same control level as when the driver does not recognize the presence of the obstacle OB even though the driver recognizes the presence of the obstacle OB. Therefore, it is possible to reduce the possibility that the driver feels that the notification control and/or the deceleration control is troublesome.

ECU 20 identifies the awareness level based on the following viewpoints 1 to 3.
Viewpoint 1: Visual recognition time Tm indicating the time when the driver is viewing the notification screen 200 (see FIG. 2).
Viewpoint 2: Display state of notification target image 205 (see FIG. 2).
Viewpoint 3: A line of sight of the driver to the notification target image 205

More specifically, ECU 20 determines whether or not the following first to fourth conditions are satisfied after the notification control is executed (after the time point t1 in FIG. 2).

### First Condition

The first criterion is satisfied when the viewing time Tm is equal to or greater than the threshold-visual recognition time Tmth. The first condition is a condition based on the above-described viewpoint 1.

ECU 20 determines whether or not the driver is visually recognizing the notification screen 200 based on the driver's seat images.

### Second Condition

The second condition is satisfied when there is only one notification target image 205 on the notification screen 200. The second condition is a condition based on the above-described viewpoint 2.

In the notification screen 200, all obstacle OB having a TTC equal to or less than the first threshold-time T1th are to be notified. When there is a plurality of notification targets, each of the plurality of notification target images 205 is highlighted using a rectangle 210.

### Third Condition

The third criterion is satisfied when the display ratio R is equal to or larger than the threshold ratio Rth. The third condition is a condition based on the above-described viewpoint 2. The display ratio R represents the ratio of the notification target part displayed as the notification target image 205 to the entire obstacle OB of the notification target.

ECU 20 stores in advance the entire area representing the entire area for each type of notification target (vehicles, persons, trees, and the like). ECU 20 specifies the type of the notification target based on the rear images, and acquires the entire area of the type. Then, ECU 20 specifies the display area of the notification target image 205 based on the distance between the notification target and the vehicle VA (specifically, the rear camera 22) and the number of pixels of the notification target image 205. ECU 20 acquires the display ratio R by dividing the specified display area by the acquired total area.

### Fourth Condition

The fourth condition is satisfied when the line of sight of the driver faces the notification target image 205 of the notification screen 200. The fourth condition is a condition based on the above-described viewpoint 3.

ECU 20 determines whether the line of sight of the driver faces the notification target image 205 based on the driver's seat image.

### Cognitive Level 1

When at least one of the first condition to the third condition is not satisfied, ECU 20 identifies the cognitive-level as “1”.

When the first condition is not satisfied, Tm of visual recognition times is short, and therefore, the driver is highly likely not to recognize the notification target.
When the second condition is not satisfied, since there is a plurality of notification targets, there is a high possibility that the driver does not recognize all of the notification targets. When the third condition is not satisfied, since the display ratio R is low, there is a high possibility that the driver does not recognize the notification target.
In the present embodiment, the cognitive level is specified (set) as one of “1”, “2”, and “3”. Recognition level “1” is the lowest level of recognition, and “3” is the highest level of recognition.

When TTC of the obstacle OB existing behind the vehicle VA is equal to or less than the first threshold-time T1th, ECU 20 executes the normal notification control. In the normal notification control, as described above, the notification screen 200 is displayed on the display device 34, and a notification sound is generated from the speaker 36. After that, when ECU 20 determines that the cognitive level is “1”, it continues the normal notification control as it is. Thereafter, if the cognitive-level is “1” when TTC of the obstacle OB reaches the second threshold-time T2th, ECU 20 executes the normal deceleration control. In the normal deceleration control, ECU 20 sets the target deceleration Gtgt to the normal target deceleration Gn.

### Awareness Level 2 and 3

When all of the first to third conditions are satisfied, ECU 20 determines whether or not the fourth condition is satisfied. In a case where the fourth condition is not satisfied, it is highly likely that the driver does not recognize the notification target as compared with a case where the fourth condition is satisfied. Therefore, when all of the first condition to the third condition are satisfied and the fourth condition is not satisfied, ECU 20 identifies the cognitive level as “2”. When the first condition to the fourth condition are satisfied, ECU 20 identifies the cognitive level as “3”.

ECU 20 switches from the normal notification control to the first suppression notification control when it is determined that the recognition level is “2” prior to TTC falling below the second threshold-time T2th. Specifically, in the first suppression notification control, the notification screen 200 is displayed on the display device 34, but the notification sound is not generated from the speaker 36. Therefore, the first suppression notification control is a control that is suppressed more than the normal notification control. In other words, the intensity (control intensity) of the notification of the first suppression notification control is weaker than the normal notification control.

If the cognitive level is “2” when TTC is less than or equal to the second threshold-time T2th, ECU 20 executes the suppression deceleration control. In the suppression deceleration control, ECU 20 sets the target deceleration Gtgt to “a suppression target deceleration Gs smaller than the normal target deceleration Gn”. Therefore, the suppression deceleration control is a control that is suppressed more than the normal deceleration control. In other words, the deceleration strength (control strength) of the suppression deceleration control is weaker than that of the normal deceleration control.

ECU 20 switches from the normal notification control to the second suppression notification control when it is determined that the recognition level is “3” prior to TTC falling below the second threshold-time T2th. Specifically, in the second suppression notification control, since the rectangle 210 is not displayed on the notification screen 200, the notification target image 205 is not highlighted. Also in the second suppression notification control, the notification sound is not generated from the speaker 36 in the same manner as in the first suppression notification control. Therefore, the second suppression notification control is a control that is suppressed more than the first suppression notification control. In other words, the intensity (control intensity) of the notification of the second suppression notification control is weaker than the first suppression notification control.

If the cognitive level is “3” when TTC is less than or equal to the second threshold-time T2th, ECU 20 does not execute the deceleration control. When the cognitive level is “3”, since the deceleration control is not executed, it can also be expressed that the control which is suppressed more than the suppression deceleration control is executed. In other words, the strength of the deceleration (control strength) with the cognitive level of “3” is weaker than the suppression deceleration control.

As described above, as the recognition level increases, the notification control and the deceleration control are suppressed. Accordingly, it is possible to reduce the possibility that the same notification control (with high control intensity) and the deceleration control are executed as in the case where the driver does not recognize the notification object even though the driver recognizes the notification object. Therefore, it is possible to reduce the possibility that the driver feels that the notification control and the deceleration control are troublesome.

### Specific Operation

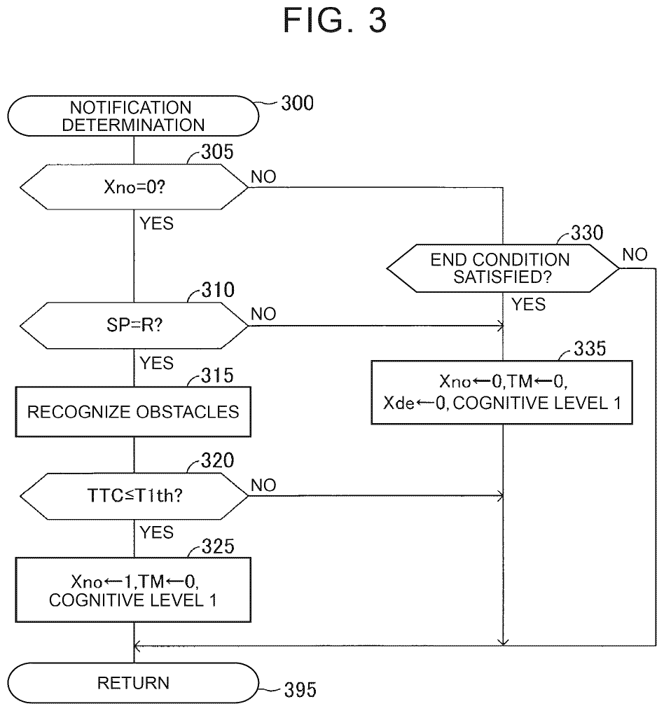

CPU of ECU 20 of the present device 10 is executed every time a predetermined period elapses in each of the routines illustrated in the flow charts in FIGS. 3 to 5.

### Notification Determination Routine

Once the appropriate time point has arrived, CPU begins processing at step 300 of FIG. 3 and processing proceeds to step 305. In step 305, CPU determines whether or not the notification flag Xno is “0”.

The notification flag Xno is set to “1” when notification control is executed, and is set to “0” when notification control is not executed. The notification flag Xno is set to “O” in the initialization routine. The initialization routine is executed by CPU when an ignition-key switch (not shown) of the vehicle VA is changed from the off-position to the on-position.

If the notification flag Xno is “1”, CPU determines “Yes” in step 305, and the process proceeds to step 310.

In step 310, CPU determines whether or not the set position SP of the shift lever is the backward position (R range).

If the set position SP is the retracted position, CPU determines “Yes” at step 310 and performs steps 315 and 320.

The stepping 315: CPU recognizes the obstacle OB based on the retracted images.

The step 320: CPU determines whether TTC of the obstacle OB is less than or equal to the first threshold-time T1th.

If TTC is greater than the first threshold-time T1th, CPU determines “No” at step 320. After that, the process proceeds to step 395, and CPU ends the routine once.

On the other hand, if TTC is less than or equal to the first threshold-time T1th, CPU determines “Yes” in step 320, and the process proceeds to step 325. In step 325, CPU sets the notification flag Xno to “1” and sets the visual recognition time timer TM to “0”. The visual recognition time timer TM is a timer for counting the viewing time Tm. Further, at step 325, CPU sets the cognitive-level to “1”. After that, the process proceeds to step 395, and CPU ends the routine once.

When the notification flag Xno is “1” when the process proceeds to step 305, CPU determines whether or not the termination condition is satisfied. When any of the following condition E1 or condition E3 is satisfied, the termination condition is satisfied.
Conditional E1: Vehicle VA is stopped.
Conditional E2: A predetermined period elapses from the starting point of the deceleration control.
Conditional E3: The driver operates a brake pedal (not shown).

If the termination condition is not satisfied, CPU determines “No” in step 330. After that, the process proceeds to step 395, and CPU ends the routine once.

When the termination condition is satisfied, CPU determines “Yes” in step 330, and the process proceeds to step 335. In step 335, CPU sets the notification flag Xno to “O” and sets the visual recognition time timer TM to “0”. Further, in step 335, CPU sets the deceleration flag Xde to “0” and the cognitive-level to “1”. After that, the process proceeds to step 395, and CPU ends the routine once.

The deceleration flag Xde is set to “1” when deceleration control is executed, and is set to “0” when deceleration control is not executed. The deceleration flag Xde is set to “O” in the initialization routine.

If the set position SP is not the retracted position when the process proceeds to step 310, CPU determines “No” in step 310, and the process proceeds to step 335.

### Cognitive Level Identification Routines

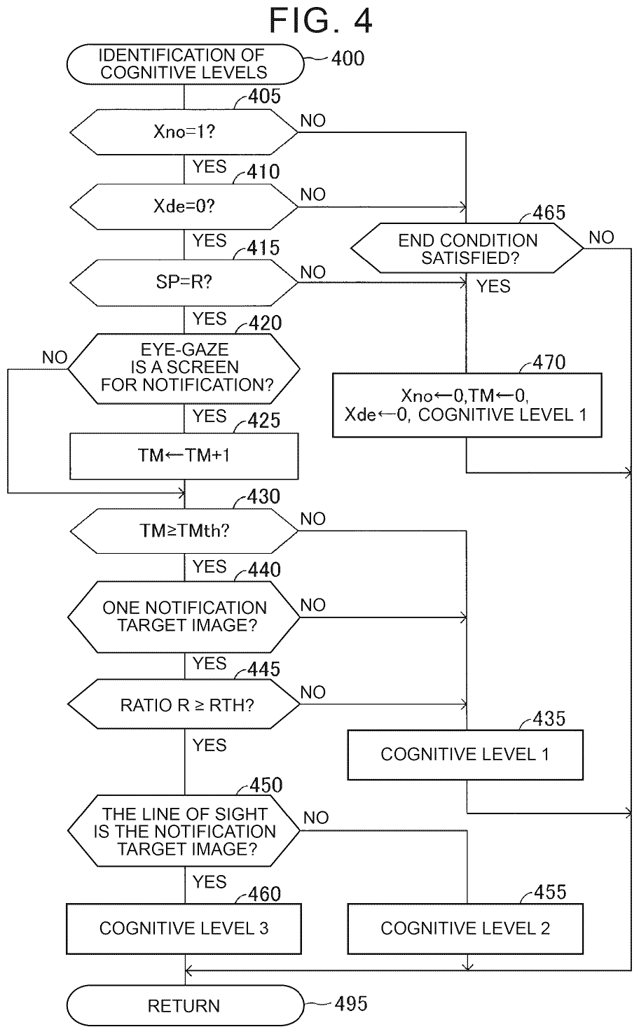

Once the appropriate time point has arrived, CPU begins processing at step 400 of FIG. 4 and processing proceeds to step 405. In step 405, CPU determines whether or not the notification flag Xno is “1”.

If the notification flag Xno is “1”, CPU determines “Yes” in step 405, and the process proceeds to step 410. In step 410, CPU determines whether or not the deceleration flag Xde is “0”.

If the deceleration flag Xde is “0”, CPU determines “Yes” in step 410, and the process proceeds to step 415. In step 415, CPU determines whether the set position SP is a retracted position.

If the set position SP is the retracted position, CPU determines “Yes” in step 415, and the process proceeds to step 420. In step 420, CPU determines whether or not the driver's line of sight is facing the notification screen 200 (i.e., whether or not the driver is viewing the notification screen 200).

If the driver's line of sight is facing the notification screen 200, CPU determines “Yes” in step 420 and executes step 425 and step 430.
425: CPU of steps adds “1” to the visual recognition time timer TM.
The step 430: CPU determines whether or not the visual recognition time timer TM is equal to or greater than the threshold value TMth. The threshold value TMth is set to the value of the visual recognition time timer TM when the visual recognition time Tm becomes equal to or larger than the threshold visual recognition time Tmth.

When the visual recognition time timer TM is less than the threshold value TMth (that is, when the viewing time Tm is less than the threshold visual recognition time Tmth), the first condition is not satisfied. In this instance, CPU determines “No” in step 430, and the process proceeds to step 435. In step 435, CPU sets the cognitive-level to “1”. After that, the process proceeds to step 495, and CPU ends the routine once.

When the process proceeds to step 430, if the visual recognition time timer TM is greater than or equal to the threshold value TMth (i.e., if the viewing time Tm is greater than or equal to the threshold visual recognition time Tmth), the first criterion is satisfied. In this instance, CPU determines “Yes” in step 430, and the process proceeds to step 440.

In step 440, CPU determines whether or not the number of notification target images 205 is one.

When there are a plurality of notification target images 205, the second condition is not satisfied. In this instance, CPU determines “No” in step 440 and sets the cognitive level to “1” in step 435. After that, the process proceeds to step 495, and CPU ends the routine once.

When there is only one notification target image 205, the second condition is satisfied. In this instance, CPU determines “Yes” in step 440, and the process proceeds to step 445.

In step 445, CPU determines whether or not the display ratio R of the notification target images 205 is equal to or greater than the threshold ratio Rth. When the display ratio R is less than the threshold ratio Rth, the third criterion is not satisfied. In this instance, CPU determines “No” in step 445 and sets the cognitive level to “1” in step 435. After that, the process proceeds to step 495, and CPU ends the routine once.

When the display ratio R is equal to or larger than the threshold ratio Rth, the third criterion is satisfied. In this case, all of the first to third conditions are satisfied. CPU determines “Yes” in step 445, and the process proceeds to step 450.

In step 450, CPU determines whether or not the driver's line of sight is facing the notification target image 205. Specifically, CPU identifies the direction of the driver's face and the direction of the line of sight based on the driver's seat images. Further, CPU obtains a height-wise distance between the driver's eyes and the display device 34 based on the driver's seat images. CPU specifies the line-of-sight position of the driver on the notification screen 200 based on the direction of the driver's face, the direction of the line-of-sight, and the distance in the height direction. When the line-of-sight position is included in the “range in which the notification target image 205 is enlarged based on the predetermined magnification”, CPU determines that the line-of-sight of the driver faces the notification target image 205.

When the line of sight of the driver does not face the notification target image 205, the fourth condition is not satisfied. In this instance, CPU determines “No” in step 450, and the process proceeds to step 455. In step 455, CPU sets the cognitive-level to “2”. After that, the process proceeds to step 495, and CPU ends the routine once.

When the line of sight of the driver faces the notification target image 205, the fourth condition is satisfied. In this instance, CPU determines “Yes” in step 450, and the process proceeds to step 460. In step 460, CPU sets the cognitive-level to “3”. After that, the process proceeds to step 495, and CPU ends the routine once.

If the notification flag Xno is “0” when the process proceeds to step 405, CPU determines “No” in step 405, and the process proceeds to step 465. In step 465, CPU describes whether or not the termination criteria are satisfied.

If the termination condition is not satisfied, CPU determines “No” in step 465. After that, the process proceeds to step 495, and CPU ends the routine once.

When the termination condition is satisfied, CPU determines “Yes” in step 465, and the process proceeds to step 470. Step 470 is the same process as step 335 shown in FIG. 3, and thus description thereof will be omitted. After that, the process proceeds to step 495, and CPU ends the routine once.

If the deceleration flag Xde is “1” when the process proceeds to step 410, CPU determines “No” in step 410, and the process proceeds to step 465. Therefore, when the deceleration flag Xde is “1”, the cognitive-level is not newly specified. If the control mode of the deceleration control is changed by changing the recognition level after the execution of the deceleration control, the driver may feel uncomfortable with respect to the deceleration control. In the present embodiment, once the deceleration control is executed, the control mode of the deceleration control is not changed since the cognitive level is not newly specified. This can reduce the possibility that the driver feels uncomfortable with the deceleration control.

If the set position SP is not the retracted position when the process proceeds to step 415, CPU determines “No” in step 415, and the process proceeds to step 470.

### Control Execution Routine

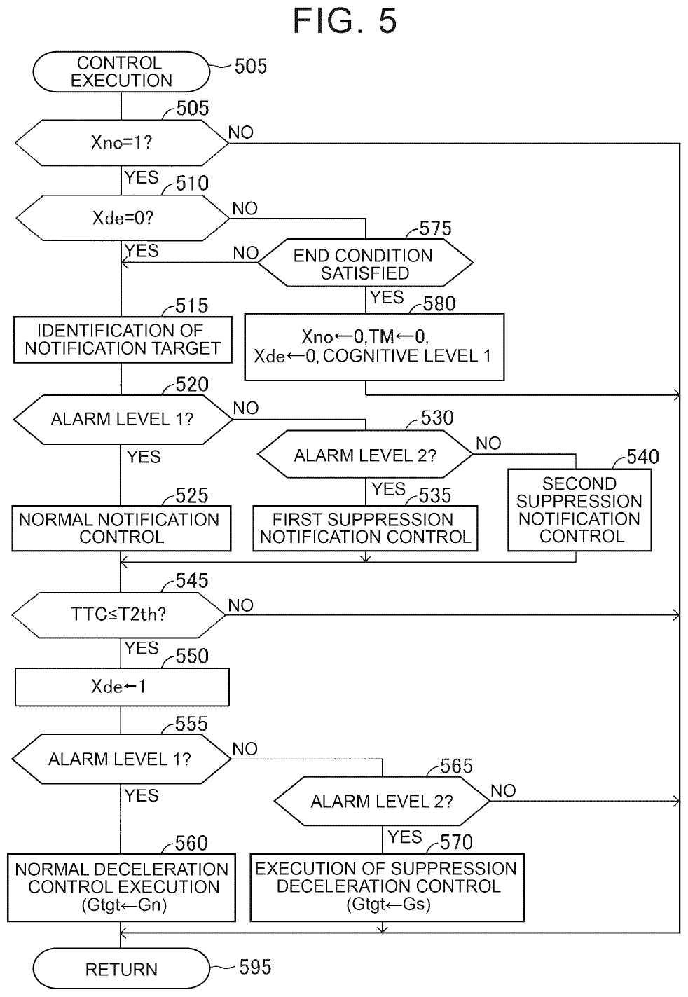

Once the appropriate time point has arrived, CPU begins processing at step 500 of FIG. 5 and processing proceeds to step 505. In step 505, CPU determines whether or not the notification flag Xno is “1”.

If the notification flag Xno is “1”, CPU determines “Yes” in step 505, and the process proceeds to step 510. In step 510, CPU determines whether or not the deceleration flag Xde is “0”.

If the deceleration flag Xde is “0”, CPU determines “Yes” in step 510 and executes steps 515 and 520.
The step 515: CPU identifies an obstacle OB having a TTC equal to or less than the first threshold-time T1th as a notification target.
The step 520: CPU determines whether or not the notification level is “1”.

If the notification level is “1”, CPU determines “Yes” in step 520, and the process proceeds to step 525. In step 525, CPU executes normal notification control to notify the driver of the presence of the obstacle OB to be notified identified in step 515.

When the notification level is not “1” (that is, when the notification level is “2” or “3”), CPU determines “No” in step 520, and the process proceeds to step 530. In step 530, CPU determines whether the notification level is “2”.

If the notification level is “2”, CPU determines “Yes” in step 530, and the process proceeds to step 535. In step 535, CPU executes the first suppression notification control.

When the notification level is not “2” (that is, when the notification level is “3”), CPU determines “No” in step 530, and the process proceeds to step 540. In step 540, CPU executes second suppression notification control.

After CPU executes the notification control in any of step 525, step 535, and step 540, the process proceeds to step 545. In step 545, CPU determines whether TTC is less than or equal to the second threshold-time T2th.

If TTC is greater than the second threshold-time T2th, CPU determines “No” at step 545. After that, the process proceeds to step 595, and CPU ends the routine once.

If TTC is less than or equal to the second threshold-time T2th, CPU determines “Yes” in step 545 and performs steps 550 and 555.
The step 550: CPU sets the deceleration flag Xde to “1”.
The step 555: CPU determines whether or not the notification level is “1”.

If the notification level is “1”, CPU determines “Yes” in step 555, and the process proceeds to step 560. In step 560, CPU performs normal deceleration control. Specifically, CPU controls the powertrain actuator 30 and the brake actuator 32 so that the acceleration G matches the normal target deceleration Gn. After that, the process proceeds to step 595, and CPU ends the routine once.

When the notification level is not “1” (that is, when the notification level is “2” or “3”), CPU determines “No” in step 555, and the process proceeds to step 565. In step 565, CPU determines whether the notification level is “2”. If the notification level is “2”, CPU determines “Yes” in step 565, and the process proceeds to step 570. In step 570, CPU performs suppression deceleration control. Specifically, CPU controls the powertrain actuator 30 and the brake actuator 32 so that the acceleration G coincides with the suppression target deceleration Gs. After that, the process proceeds to step 595, and CPU ends the routine once.

When the notification level is not “2” (that is, when the notification level is “3”), CPU determines “No” in step 565. After that, the process proceeds to step 595, and CPU ends the routine once. As a result, when the notification level is “3”, the deceleration control is not executed.

If the deceleration flag Xde is “1” when the process proceeds to step 510, CPU determines “No” in step 510, and the process proceeds to step 575. In step 575, CPU determines whether the termination condition is satisfied. In step 575, CPU may determine that the termination condition is satisfied even when the set position SP is not the retracted position.

If the termination condition is not satisfied, CPU determines “No” in step 575, and the process proceeds to step 515. On the other hand, if the termination condition is satisfied, CPU determines “Yes” in step 575, and the process proceeds to step 580. Step 580 is the same process as step 335 shown in FIG. 3, and thus description thereof will be omitted. After that, the process proceeds to step 595, and CPU ends the routine once.

According to the present embodiment, the notification control and the deceleration control are suppressed as the recognition level increases. Accordingly, it is possible to reduce the possibility that the notification control and the deceleration control with high control strength are executed even though the driver recognizes the notification target. Therefore, it is possible to reduce the possibility that the driver feels that the notification control and the deceleration control are troublesome.

### First Modification

In the above embodiment, the control modes of both the notification control and the deceleration control are changed based on the recognition level, but the control mode of either the notification control or the deceleration control may be changed based on the recognition level.

### Second Modification

In the above-described embodiment, when the cognitive level is “3”, the deceleration control is not executed (see the step 565″No shown in FIG. 5), but when the cognitive level is “3”, the deceleration control which is suppressed more than the suppression deceleration control may be executed. In the deceleration control, the target deceleration Gtgt is set to a target deceleration Gs' smaller than the suppression target deceleration Gs.

### Third Modification

The threshold values used in the first to fourth conditions of the above-described embodiment (the “threshold visula recognition time Tmth” in the first condition, the “number of notification target images 205” in the second condition, the “threshold ratio Rth” in the third condition, and the “enlargement magnification” in the fourth condition) may be changeable based on the designation of the driver. In other words, the ease of establishment of the first condition to the fourth condition may be changeable (the criterion of increasing or decreasing the recognition level may be changeable based on the driver's designation).

### Fourth Modification

In the above-described embodiment, TTC is used as an index of the touch-risk, but the present disclosure is not limited thereto. For example, the distance between the obstacle OB and the vehicle VA may be used as an index of the contact risk.

### Fifth Modification

The method of suppressing the notification control is not limited to the method described in the above embodiment. For example, the notification control may be suppressed by the color of the rectangle 210. Specifically, in the normal notification control, the rectangle 210 may be displayed in red, in the first suppression notification control, the rectangle 210 may be displayed in yellow, and in the second suppression notification control, the rectangle 210 may be displayed in white.

### Sixth Modification

In the above-described embodiment, the target deceleration Gtgt of the deceleration control is set to a small value as the cognitive level increases, but the method of suppressing the deceleration control is not limited thereto. For example, the deceleration control may be suppressed by delaying the start timing of the deceleration control as the cognitive level increases. Specifically, the second threshold-time T2th may be set to a smaller value as the cognitive level increases.

### Seventh Modification

In the above-described embodiment, the notification control and the deceleration control are executed when the vehicle VA is moving backward, but the notification control and the deceleration control may be executed when the vehicle VA is moving forward.

### Eighth Modification

In the above-described embodiment, the cognitive level is set to “2” or “3” when all of the first to third conditions are satisfied. When at least one of the first condition to the third condition is satisfied, the cognitive level may be set to “2” or “3”. Furthermore, the determination of the fourth condition is not essential.

### Ninth Modification

In the above embodiment, the cognitive level is not newly specified once the deceleration control is executed, but the present disclosure is not limited thereto. Even if the deceleration control is executed once, the cognitive level may be newly specified, and the control mode of the deceleration control may be changed.

The present device 10 is applicable to vehicles such as engine vehicles, hybrid electric vehicle, plug-in hybrid vehicles, fuel cell electric vehicle, and battery electric vehicle. Furthermore, the present device 10 is also applicable to an autonomous vehicle.

What is claimed is:

1. A drive assist device configured to perform notification control for notifying a driver of presence of an obstacle when a risk of contact between the obstacle and a vehicle is equal to or more than a first threshold value, and to perform deceleration control for decelerating the vehicle when the risk of contact is equal to or more than a second threshold value larger than the first threshold value, wherein
the drive assist device is configured to:
specify a recognition level of the driver for a notification by the notification control; and
change a control mode of at least one of the notification control and the deceleration control based on the recognition level.

2. The drive assist device according to claim 1, wherein the drive assist device is configured to:
in the notification control, cause a display device disposed in the vehicle to display a notification screen for notifying the driver of the presence of the obstacle;
specify the recognition level based on a state of visual recognition of the notification screen by the driver; and
suppress at least one of the notification control and the deceleration control when the recognition level is high, as compared with when the recognition level is low.

3. The drive assist device according to claim 2, wherein the drive assist device is configured to reduce strength of deceleration of the deceleration control when the recognition level is high, as compared with when the recognition level is low.

4. The drive assist device according to claim 2, wherein the drive assist device is configured to specify the recognition level based on at least one of a visual recognition time during which the driver visually recognizes the notification screen, a display state of the obstacle on the notification screen, and a line of sight of the driver to the obstacle displayed on the notification screen.

5. The drive assist device according to claim 1, wherein the drive assist device is configured to change a criterion of whether to increase or decrease the recognition level based on a designation by the driver.
